(19) United States
(12) Patent Application Publication
(10) Pub. No.: US 2013/0167044 A1
(43) Pub. Date: Jun. 27, 2013

(54) System and Method for Providing Directed Video Within a Chat Application

(71) Applicants: Gary Graves, Wildwood, NJ (US); Jack Behar, Cypress, TX (US); Charles Brogna, Cypress, TX (US)

(72) Inventors: Gary Graves, Wildwood, NJ (US); Jack Behar, Cypress, TX (US); Charles Brogna, Cypress, TX (US)

(73) Assignee: VISUALLY LINKED LLC, Cypress, TX (US)

(21) Appl. No.: 13/337,886

(22) Filed: Dec. 27, 2011

(51) Int. Cl. G06F 3/048; G06F 15/16

(52) U.S. Cl. 715/756

(57) ABSTRACT

A system and method are provided for delivering directed video content within a chat application. In response to a request to initiate a chat session generated by a user, a chat application is initiated. The chat application collects information associated with the user. The collected information may include contact information, demographic information, and information identifying products and services in which the user is interested. Based on the collected information, the chat application selects video content to be displayed to the user within a chat application interface.

### FIELD OF DISCLOSURE

This disclosure relates generally to a system and method for providing video within a consumer chat application. More particularly, but not by way of limitation, this disclosure is related to the provision of directed video advertisements within a consumer chat application.

### BACKGROUND

Consumers utilize the Internet to engage in a wide variety of transactions. It has become commonplace for consumers to browse for products, purchase products, and seek customer service online. Therefore, it is critically important for providers of the products and services that the consumers desire to maintain an online presence and to provide every possible interface by which the provider and consumer can interact. As one effect of the desire of providers to interact with consumers online, it has become common for businesses to offer consumers browsing their website an opportunity to chat with a sales representative or customer service representative. Oftentimes, a consumer browsing the website of a business can request to initiate a chat session by launching a chat application from almost any page of the business' website.

Businesses providing consumers with the ability to chat online typically do so utilizing three primary mechanisms. According to a first, stand-alone chat mechanism, when a consumer launches a chat application from a business' website, the consumer will chat directly with an employee or other person closely related to the business. For example, a consumer launching a chat application from an auto dealership website might be connected to a salesperson employed by the dealership. According to a second, third-party chat mechanism, when a consumer launches a chat application from a business' website, the consumer will chat with a person at a chat call center that the business has retained to provide such a service. Typically, the business will provide the chat call center with a “script” or a list of answers to frequently asked questions such that the chat call center can communicate with the consumer. Because interaction based on this mechanism is often based on a “script” or predetermined list of answers, the third-party chat mechanism typically cannot provide the same level of personal interaction as the stand-alone mechanism. Finally, according to a third, hybrid chat mechanism, when a consumer launches a chat application from a business' website, the consumer will chat with an employee of the business if the chat request is received during a first time period (e.g., during normal business hours) and with a person at a chat call center if the chat request is received during a second time period (e.g., during holidays or busy periods). The hybrid mechanism allows a business to provide the more personal interaction of the stand-alone mechanism when possible and to ensure that interaction via the third-party mechanism is available to consumers hen it is not possible to provide the stand-alone mechanism.

Regardless of the selected mechanism, a chat application is commonly (though not necessarily) hosted by a remote third party. That is, when the chat application is initiated from a page of a business' website, the consumer and either an employee of the business or a chat call center (depending on the mechanism) will interact via a chat application that is provided by a third party. The third party chat application is typically hosted on a web server located remotely from the web server that hosts the content of the business' website.

After a chat application is initiated, information (e.g., consumer's age, location, contact information, the subject of the chat request, etc.) may be obtained from the consumer before the chat request is routed to the appropriate party (i.e., the appropriate employee or chat call center). Typically, there will be a short delay before the chat request is answered by the chat representative. During this delay, the consumer is likely in an attentive state as they await a response from the chat representative. Therefore, this delay represents an unutilized opportunity to interact with the consumer.

### BRIEF DESCRIPTION OF THE DRAWINGS

FIG. 1 is a block diagram illustrating network architecture 100 according to one embodiment.

FIG. 2 is a block diagram illustrating a computer on which software according to one embodiment may be installed.

FIG. 3 illustrates a chat application interface launched from within a web browser according to one embodiment.

FIG. 4 is a flowchart illustrating a process for selecting and displaying video content within a chat application prior to a chat request being answered by a chat representative according to one embodiment.

FIG. 5 is a flowchart illustrating a process for selecting and displaying video content within a chat application after a chat request is answered by a chat representative according to one embodiment.

FIG. 6 illustrates additional features available within a chat application interface according to one embodiment.

### DETAILED DESCRIPTION

Various embodiments, described in more detail below, provide a technique for selecting and delivering video content within a chat application. The detailed description will present information to enable one of ordinary skill in the art of web and computer technology to understand the disclosed methods and systems.

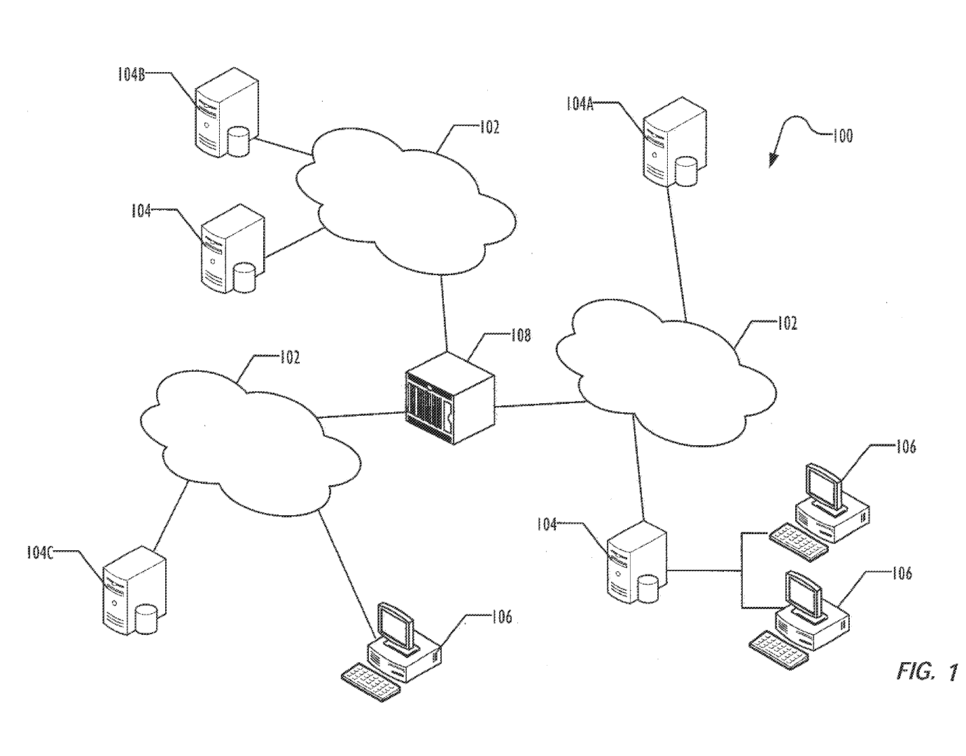

FIG. 1 illustrates network architecture 100 in accordance with one embodiment. As shown, a plurality of networks 102 is provided. In the context of the present network architecture 100, networks 102 may each take any form including, but not limited to, a local area network (LAN), a wireless network, a wide area network (WAN) such as the Internet, etc.

Coupled to networks 102 are data server computers 104 which are capable of communicating over networks 102. Although structurally similar, data server computers 104 may be utilized for different functions as will be described in detail below. For example, data server computers 104 may include ad servers 104A to host advertisement content, web servers 104B to host web content, and chat application servers 104C to host chat applications. For purposes of this disclosure, the term “host” is used to describe a network node that offers content, resources, and applications to other network nodes. As will be understood by one of ordinary skill hi the art, operations of an application performed by a client device are referred to as client-side operations whereas operations of an application performed by a server device are referred to as server-side applications. Also coupled to networks 102 and data server computers 104 is a plurality of client computers 106. In accordance with one embodiment, client computers 106 may utilize the content, resources, and/or applications provided by the various data server computers 104. Such data server computers 104 and/or client computers 106 may each include a desktop computer, lap-top computer, hand-held computer, mobile phone, peripheral (e.g. printer, etc.), any component of a computer, and/or any other type of logic. In order to facilitate communication among networks 102, at least one gateway or router 108 is optionally coupled there between.

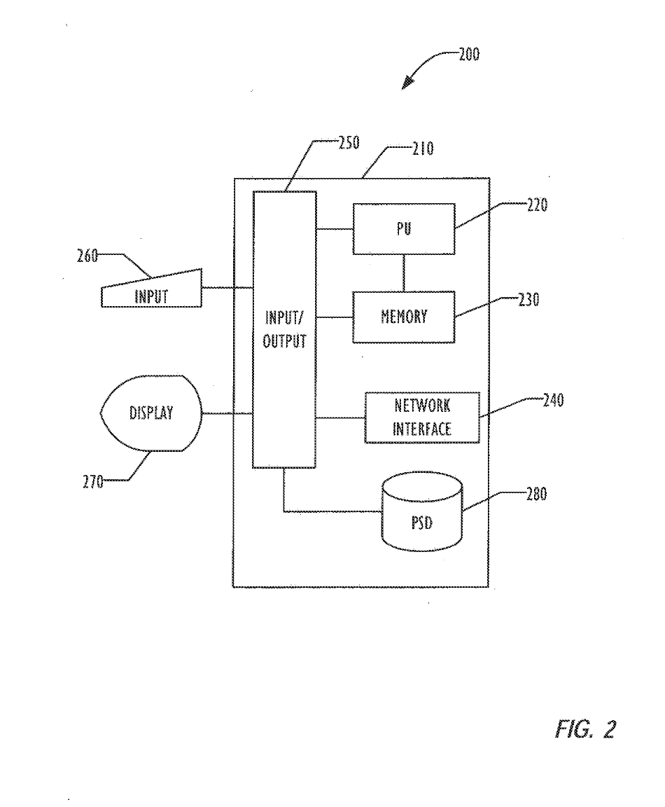

Referring now to FIG. 2, an example processing device 200 for use in providing video content within a consumer chat application according to one embodiment is illustrated in block diagram form. Processing device 200 may serve as a gateway or router 108, client computer 106, or a data server computer 104. Example processing device 200 comprises a system unit 210 which may be optionally connected to one or more input devices for system 260 (e.g., keyboard, mouse, touch screen, microphone, camera, etc.) and display 270. A program storage device (PSD) 280 (sometimes referred to as a hard disc or computer readable medium) is included with the system unit 210. Also included with system unit 210 is a network interface 240 for communication via a network with other computing and corporate infrastructure devices (not shown). Network interface 240 may be included within system unit 210 or be external to system unit 210. In either case, system unit 210 will be communicatively coupled to network interface 240. Program storage device 280 represents any form of non-volatile storage including, but not limited to, all forms of optical and magnetic memory, including solid-state, storage elements, including removable media, and may be included within system unit 210 or be external to system unit 210. Program storage device 280 may be used for storage of software to control system unit 210, data for use by the processing device 200, or both.

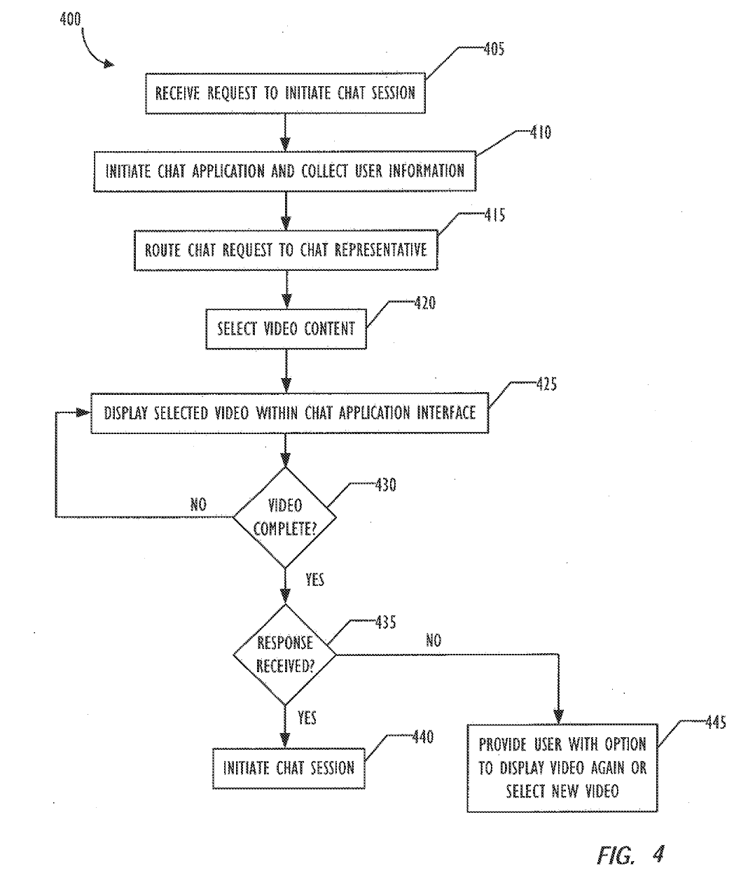

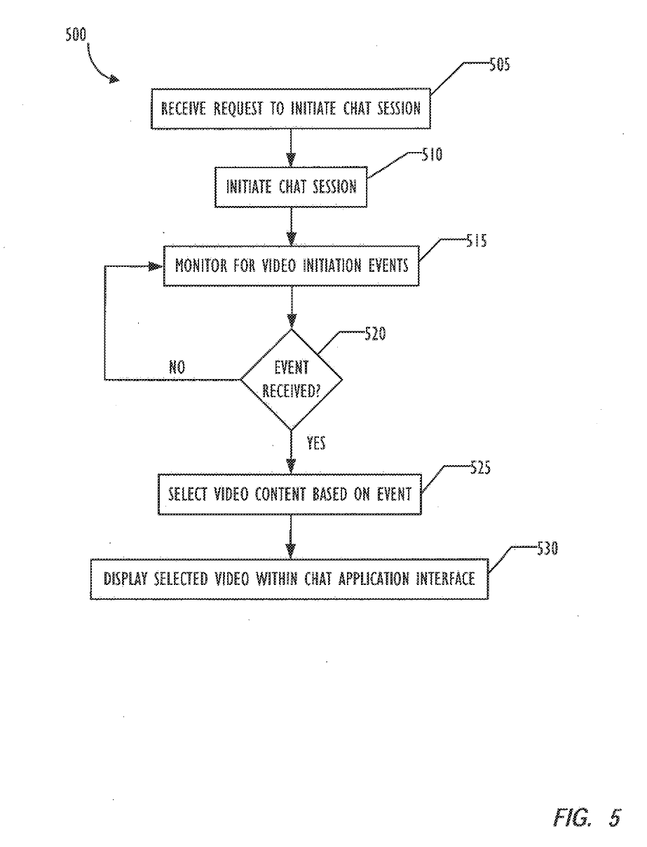

System unit 210 may be programmed to perform methods in accordance with this disclosure (examples of which are in FIGS. 4 and 5). System unit 210 comprises a processor unit (PU) 220, input-output (I/O) interface 250 and memory 230. Processing unit 220 may include any programmable controller device including, for example, a mainframe processor, or one or more members of the Intel Atom®, Core®, Pentium® and Celeron® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company). Memory 230 may include one or more memory modules and comprise random access memory (RAM), read only memory (ROM), programmable read only memory (PROM), programmable read-write memory, and solid-state memory. PU 220 may also include some internal memory including, for example, cache memory.

Processing device 200 may have resident thereon any desired operating system. Embodiments may be implemented using any desired programming languages, and may be implemented as one or more executable programs, which may link to external libraries of executable routines that may be provided by the provider of the operating system or any other desired provider of suitable library routines. As used herein, the term “a computer system” can refer to a single computer or a plurality of computers working together to perform the function described as being performed on or by a computer system.

In preparation for performing disclosed embodiments on processing device 200, program instructions to configure processing device 200 to perform disclosed embodiments may be provided stored on any type of non-transitory computer-readable media, or may be downloaded from a server 104 onto program storage device 280.

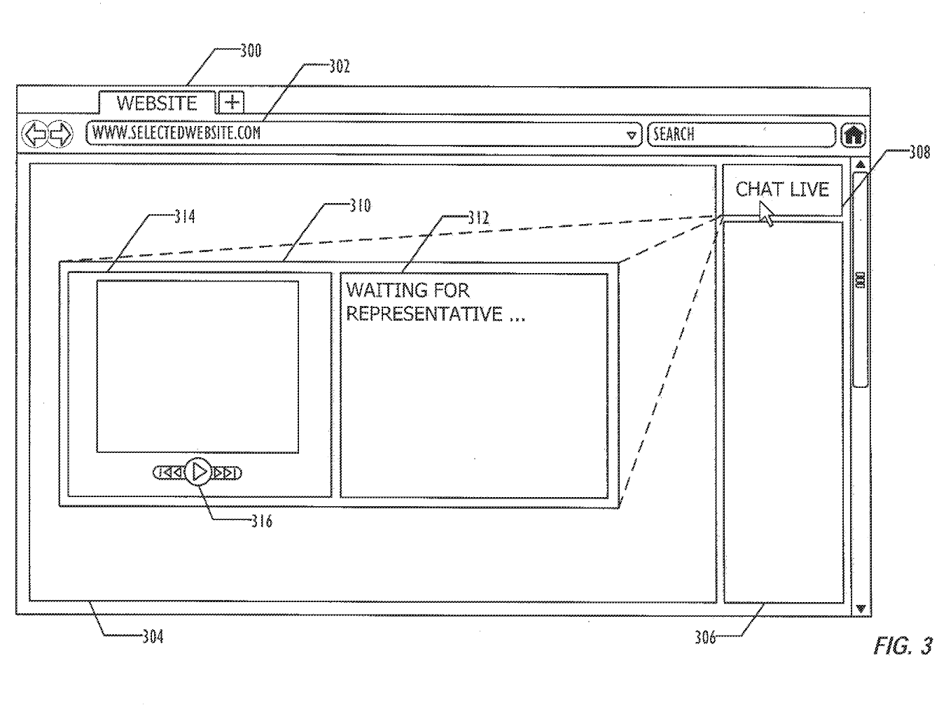

Referring now to FIG. 3, in the depicted embodiment, a web browser 300 operable on a client computer 106 enables a user to retrieve desired content via the Internet. Such content may be available in the form of a website 302 hosted, for example, on a web server 104B. As illustrated in FIG. 3, web browser 300 is utilized to navigate to a desired website 302 that contains a collection of web pages that are capable of being displayed by the browser 300 in a manner that is interpretable by the user. The web pages may provide content 304 such as text, images, audio, video, and other executable applications. Content 304 may also include hyperlinks to facilitate navigation to other web pages and resources, both internal to website 302 and external to website 302. Additionally, a portion 306 of one or more web pages of website 302 may display content that is hosted on a remote web server. For example, the portion 306 of the web page may be dedicated to displaying advertisements hosted on an ad server 104A located remotely from web server 104B. As described above, it has become common for businesses having a website 302 to provide a user with the ability to initiate an online chat session with a chat representative such as a sales representative, customer service representative, etc. Typically, a chat request interface 308 may appear on one or more web pages associated with the website 302. By selecting the chat request interface 308, for example utilizing an input 260 of the client computer 106, a chat application will be initiated and a chat application interface 310 displayed on the client computer 106 of the user. In one embodiment, rather than the static chat request interface 308 illustrated in FIG. 3, a user may be invited to participate in a chat session. For example, the website might display a popup window asking the user if they would be interested in a chat session. In one embodiment, such an invitation may be based on the user's browsing history. For example, if the user has browsed to a particular web page of the website 302 a predefined number of times, the user may be invited to participate in a chat session.

In one embodiment, the chat application may be hosted on a chat application server 104C located remotely from web server 104B. In one embodiment, the chat application will cause the chat application interface 310 to be displayed on the client computer 106 of the user. The chat application interface 310 may be provided within a separate browser window. The chat application routes the chat request to the appropriate chat representative and provides an interface between the user and the chat representative via a text dialog frame 312 within the chat application interface 310. The chat application interface 310 additionally contains a video display frame 314 for displaying video content selected and delivered by the chat application according to various embodiments. The user may be capable of controlling the video from within the chat application interface 310 using the video controls 316.

Referring now to FIG. 4, a flow chart illustrates a method 400 for providing video content within a chat application prior to a chat request being answered by a chat representative. In a first step 405, a request to initiate a chat session is received. In one embodiment, the request may be received at a chat application server 104C. As described above, the request to initiate the chat session may be received in response to a user selecting a chat request interface 308 from a webpage providing such an interface. In another embodiment, the request may be received in response to a user's affirmative response to an invitation to initiate a chat session. In one embodiment, the request may be received at a web server 104B that hosts the website 302 that provides the chat request interface 308. In one embodiment, the request may be forwarded from the web server 104B to a chat application server 104C that hosts the chat application.

In response to receiving the request, at 410 the chat application is initiated and collects information associated with the user. In one embodiment, the chat application may display an information collection form. The information collection form may provide entry fields to be completed by the user. In one embodiment, the information collection form may be required to be completed and submitted by the user prior to a chat request being routed to a chat representative. The information collection form may be tailored to collect information that is of particular interest to a business that operates the website 302 from which the chat request was generated. The information associated with the user may include contact information, demographic information, and information pertaining to the particular products and/or services in which the user is interested. In another embodiment, information about the user may be collected automatically. For example, a particular product or service in which the user is interested may be inferred based on the web page from which the user selected a chat request interface 308. In another embodiment, a particular product or service in which the user is interested may be inferred based on the web browsing history of the user. For example, even if a user selects a chat request interface 308 from a web page that is not associated with a particular product, the user may be determined to be interested in the particular product based on the user's history of browsing to a web page associated with the particular product. In another embodiment, contact information associated with a user may be collected automatically. For example, if a user selects a chat request interface 308 (or responds affirmatively to a chat invitation) from a web page to which the user was authenticated by providing login information, known information associated with the user may be collected by the chat application. For example, if a user logs in to view an account on an online banking website and subsequently requests to chat with a customer service representative, the chat application may collect known information associated with the user such as contact and account information.

After the information is collected by the chat application, at 415 the chat application routes the chat request to the appropriate chat representative. As indicated above, the appropriate chat representative may be selected by a predetermined arrangement. For example, the chat request may be routed to a chat call center or to a representative affiliated with the business providing the website 302 from which the chat request was generated according to a predetermined chat mechanism. In one embodiment, the chat request may be routed to the chat representative by displaying a chat application interface 310 on a client computer 106 of the chat representative. In another embodiment, the chat representative may receive a phone call or SMS message alerting them that a request to initiate a chat session has been received.

Typically, there will be a short delay before the chat representative is able to answer the chat request and interact with the user via the chat application interface 310. Thus, the user is typically in an attentive state as they wait to interact with the chat representative. As such, the short delay provides an opportune time for a business to interact with the user. Moreover, the information collected at 410 provides an opportunity for a targeted interaction with the user. At 420, an appropriate video is selected. In one embodiment, the video is an advertisement. Based on the Information collected at 410, a video advertisement can be targeted to the user's interests,

Several example mechanisms for the selection of appropriate video advertisements will now be discussed. In a first embodiment, the video selection may be based on a web page from which the request to initiate a chat session was generated. Just by way of example, a chat session request generated from a higher level web page (e.g., www.companyA.com) may result in a more generic advertisement than a chat session request generated from a lower level web page (e.g., www.companyA.com/productB). In the context of a car dealership, a generic advertisement may provide information about the manufacturer's safety record, the dealership, or automobile insurance. In the context of a real estate agency, a generic advertisement may provide statistics for the agency, a furniture or appliance ad, or information regarding homeowner's insurance policies. Conversely, more specific advertisements may be provided from lower level web pages. In the context of an automobile dealership or manufacturer, a specific advertisement may provide information about a particular vehicle model associated with the web page from which the chat request was generated. In one embodiment, the video advertisement may be customized based on features that are known to be preferred by the user. For example, many vehicle manufacturers provide web pages that allow consumers to customize a vehicle online (i.e., select a model, trim level, color, options, etc.). A chat request generated from such a web page may result in the selection of a video advertisement that displays the product with the features preferred by the user. In the context of a real estate agency, a specific advertisement may provide a virtual tour of a home associated with the web page from which the chat request was generated.

In another embodiment, demographic information may be used in conjunction with information pertaining to the products and/or services in which the user is interested to select the appropriate video. Therefore, the advertisement may be tailored to the particular consumer based on the collected demographic information. For example, even where the collected information indicates that two users are interested in the same product, different video advertisements may be delivered based on differences in the collected demographic information. That is, demographic information may dictate that different video advertisements, each promoting the same product in which the two users are interested, be selected. Just by way of example, demographic information may be utilized to select an entirely different advertisement for the same product, adjust background music of the advertisement, or adjust the manner in which the product is depicted in the advertisement.

In another embodiment, the video selection decision may incorporate information related to an estimated duration of the delay before the chat representative will be available. For example, if a chat call center is experiencing high chat request volume, the estimated delay may be slightly longer than in times of normal chat request volume. Therefore, the video selection decision may incorporate this information to select a slightly longer video for display.

At 125, the selected video is displayed within the chat application interface 310 on the client computer 106 of the user. For example, the video may be displayed in video display frame 314. In one embodiment, the video content is hosted on a chat application server 104C hosting the chat application. In another embodiment, the video is hosted on an ad server 104A located remotely from chat application server 104C. If the video content is hosted on a remotely located ad server 104A, a request for the appropriate video content may be sent from the chat application server 104C to the ad server 104A. That is, based on the collected information, the chat application may determine the desired video content at 420 and may request the specific content from ad server 104A. In one embodiment, the ad server 104A may respond to the chat application server 104C with a uniform resource locator (URL) from which the desired video content can be obtained. In another embodiment, the chat application server 104C may simply forward the collected information to the ad server 104A and defer to the ad server 104A to make the video selection decision 420. Regardless of where the video content is hosted, the selected video data is delivered to the client computer 106 of the user and displayed within the chat application interface 310 to be viewed by the user. For purposes of this disclosure, video data is “delivered” from a host location by any means that allow the video to be viewed at a remote location. For example, video data is “delivered” when it is streamed from the host location, downloaded from the host location, etc.

The progress of the video is continuously monitored and, at 430, it is determined if the video is complete. If it is determined at 430 that the video is not complete, the video continues to be displayed within the chat application interface 310 and monitoring of the progress of the video continues. If it is determined at 430 that the video is complete, however, it is further determined at 435 if a response has been received from the chat representative indicating that the representative is ready to initiate the chat session. If the chat representative is available, the chat session is initiated at 440 and the user and the chat representative interact via the chat application interface 310, for example utilizing text dialog frame 312. For purposes of this disclosure, the chat session is initiated when each party to the chat session is available and the parties begin interfacing through the chat application. It should be noted, therefore, that initiation of a chat application and initiation of a chat session, as used herein, refer to two different processes. The displayed video may provide a convenient avenue for the chat representative and the user to begin their discussion. For example, the user may indicate that they are interested in the product that they just observed in a video advertisement and might ask if the product is available with certain options. If it is determined at 435 that the chat representative is not yet available, the user may be given the opportunity to replay the displayed video or to select another video at 445. In one embodiment, the video selection decision 420 may rank a predetermined number of videos based on appropriateness for the user. The most appropriate video may be displayed at 425 and the full list of ranked videos may be presented to the user at 445 to allow the user to select the same or different video for display. While several mechanisms for the display of video content within a chat application have been described, one of ordinary skill in the art will recognize that additional methods may be employed. As such, the described mechanisms are provided as examples and are not intended to limit the scope of the disclosure.

Referring now to FIG. 5, a flow chart illustrates a method 500 for providing video content within a chat application during a chat session. In a first step 505, a request to initiate a chat session is received. As described above with respect to FIG. 4, the request may be received at a chat application server 104C and may be received in response to the selection of a chat request interface 308 by a user. As also described above, the chat application may route the request to the appropriate chat representative.

At 510, the chat session is initiated when the chat representative answers the request and begins an interaction with the user via the chat application interface 310, for example within text dialog frame 312. As described above, there may be a short delay after the request to initiate a chat session before the chat representative is available. Therefore, a substantial portion of the events described with respect to FIG. 5 may occur after the events described with respect to FIG. 4. As the user and the chat representative interact via the chat application interface 310, the chat application continuously monitors for video initiation events at 515. Several events may be predetermined to qualify as video initiation events.

In one embodiment, the chat representative may manually generate a video initiation event. For example, based on the status of the chat, the chat representative may determine that the user is interested in a particular product or information pertaining to a particular product. The chat representative may therefore manually generate a video initiation event based on the interests of the user. In one embodiment, the manual generation of the video initiation event may be implemented through a video initiation event interface provided within the chat application. The video initiation event interface may allow the chat representative to perform a keyword search for video content based on the interests of the user. In one embodiment, the video initiation event interface may only be available to the chat representative and not to the user. In one embodiment, the consumer may be able to request that the chat representative initiate a certain video using the text dialog frame 312. In another embodiment, the video initiation event interface may be available to both the user and the chat representative. For example, both the user and the chat representative may be capable of selecting a particular video from a list or searching for a video using a keyword search feature of the video initiation event interface.

In another embodiment, a video initiation event may occur automatically. For example, the use of predetermined keywords within the text dialog frame 312 may cause a video initiation event to be generated automatically. Therefore, if the user or chat representative uses the predetermined keyword, for example the name of a particular product, a certain number of times during the chat session, a video initiation event may be automatically generated.

In still another embodiment, the chat application may provide additional features beyond ordinary text interaction, as described below. In one embodiment, one of the additional features may allow the user or the chat representative to interact via a video chat session. Therefore, as described in greater detail below, either the chat representative or the user may be able to request a video chat session from within the chat application interface 310. Accordingly, a request to initiate a video chat session will generate a video initiation event.

At 520, it is determined whether a video initiation event has been received. If no video initiation event is received at 520, the chat application continues to monitor for video in initiation events at 515. If, however, a video initiation event is received at 520, the appropriate video content based on the initiation event is selected at 525. The selection of video content may include any of the methods described above with respect to FIG. 4. The appropriate video selection will be based on the type of video initiation event. For example, if the video initiation event is generated manually by either the chat representative or the user, the appropriate video may be based entirely on the specific video requested. If the initiation event occurs automatically based on keyword usage during the chat session, the chat application may determine the appropriate video. In one embodiment, a specific keyword may be tied to a single video. In another embodiment, the specific keyword may be used in conjunction with additional information, for example information collected as described in 420 above, to determine an appropriate video. In still another embodiment, the context of the keyword usage may be considered in determining an appropriate video. For example, if the chat session involves the discussion of a vehicle, the vehicle model may be the keyword utilized to generate the automatic video initiation event and the user's mention of a particular color during the chat session may be utilized customize the video selection decision to deliver an advertisement displaying the desired model in the desired color. If the initiation event occurs as the result of a request for video chat by either party, the selected video will be based on an input from a video camera connected to the client computers 106 of the chat representative and the user. Finally, at 530 the selected video is displayed within the chat application interface 310. Therefore, in addition to the ability to display directed videos prior to the chat session being initiated, the video display frame 314 can also be utilized during a chat session.

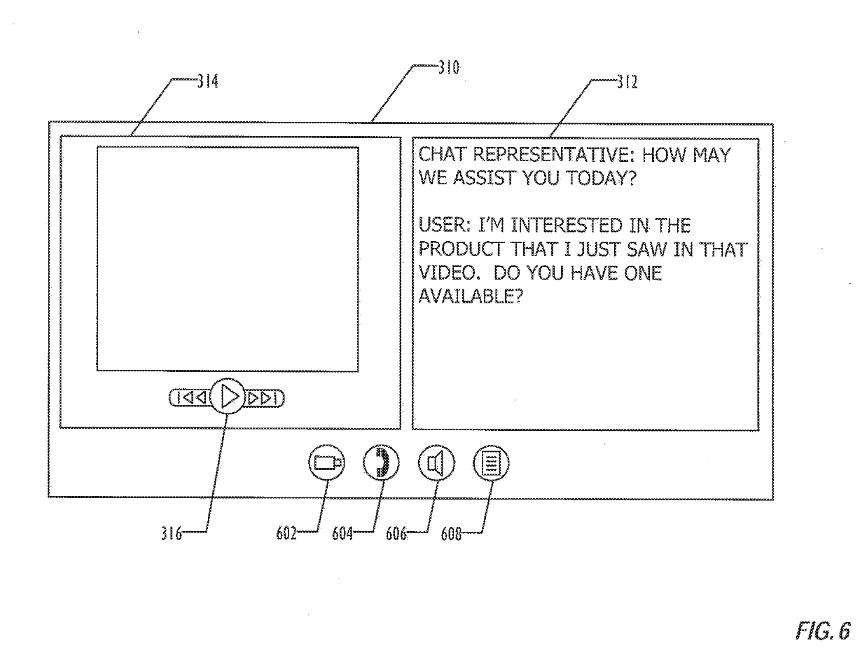

Referring now to FIG. 6, additional features of a chat application interface 310 in accordance with a particular embodiment are depicted. In addition to the interaction provided via text dialog frame 312 and video display frame 314, chat application interface 310 may provide additional communication mechanisms and features. In one embodiment, as briefly mentioned above, chat application interface 310 may provide a user and a chat representative with the ability to initiate a video chat session. Video chat allows each party to see and hear the other party. Video data is captured by a camera connected to a client computer 106 and voice data is captured by a microphone connected to the client computer 106. Video and voice data that is captured at the client computer 106 of one party to the chat session is reproduced at the client computer 106 of the other party to the chat session. Therefore, a video chat session may allow the user and the chat representative to interact using a ore personal form of communication. In one embodiment, a request to initiate a video chat session may be generated by either party to the chat session by selecting the video chat icon 602. In response to the request to initiate the video chat session, the party that did not generate the request may be prompted to indicate whether they consent to using video chat. In one embodiment, if both parties to the chat session agree to the request to initiate a video chat session, a live video of the other party will be displayed in the video display frame 314. In one embodiment, the chat application may continuously monitor properties during a chat session to determine whether video chat is an option. These properties may include hardware and/or connection speeds associated with the participating client computers 106. In one embodiment, if video chat is not an option for one of the parties to the chat session, video chat icon 602 may not be selectable by either party.

Chat application interface 310 may additionally provide an option to initiate a telephone call. A telephone call may be initiated by either party to the chat session by selecting the telephone icon 604. In one embodiment, the user's telephone number may be collected as part of the information collected at step 410, described above. In another embodiment, the user's telephone number may be collected from within the text dialog frame 312. The chat representative's telephone number may be known based on a chat account associated with the chat representative. For example, when the chat representative is notified of a request to initiate a chat session, the representative may log in to the chat application using an account such that all information associated with the account (e.g., the representative's telephone number) is available. In one embodiment, the telephone icon may allow a chat representative to connect the user by telephone to a representative that is more familiar with the product or service in which the user is interested. Thus, selection of the telephone icon 604 by the chat representative (e.g., within a chat account) may prompt the chat representative to provide a telephone number of the representative to which the call should be connected. In another embodiment, a chat representative may be able to connect the user by telephone to an employee or representative of a business that is assigned to receive such calls. For example, although a business may select either the third-party or hybrid chat mechanism described above, a chat call center representative may be instructed to forward serious inquiries to a representative or employee of the business assigned to receive such inquiries. In one embodiment, the chat representative may connect the user to a 1-800 number that can provide greater assistance. If each of the parties to the chat session consents to a telephone call, the telephone call may be automatically initiated by the chat application.

Chat application interface 310 may also provide an option to initiate a voice chat session. A voice chat session may be initiated by either party to the chat by selecting the voice chat icon 606. Voice chat allows the parties to communicate by speaking into a microphone connected to the client computer. Voice data that is captured at the client computer 106 of one party to the chat session is reproduced at the client computer 106 of the other party to the chat session. In one embodiment, the chat application may continuously monitor properties during a chat session to determine whether voice chat is an option. These properties may include hardware and/or connection speeds associated with the participating client computers 106. In one embodiment, if voice chat is not an option for one of the parties to the chat session, voice chat icon 606 may not be selectable by either party. If both parties to the chat session consent, the voice chat session may be initiated by the chat application.

Chat application interface 310 may additionally provide the ability to record notes. Although the transcript of the communication in the text dialog frame 312 may not be available to either party to the chat session after the chat session is concluded, the chat application interface 310 might allow either party to record notes. In one embodiment, either party may request to record notes during the chat session by selecting the notes icon 608. The notes icon 608 may initiate a form in which notes can be recorded. In one embodiment, the recorded notes may be delivered to a party by email or SMS message. As noted above, contact information (such as email address and telephone number) associated with the user may be collected in step 410 and contact information associated with the chat representative may be available based on the representative's chat account. Therefore, the chat application may utilize the known contact information of the parties to the chat session to deliver recorded notes. In one embodiment, notes may be delivered to the other party to the chat session. For example, in the context of an auto dealership, a chat representative may record vehicle identification numbers of available vehicles matching the user's interests and deliver the note to the user. Conversely, the user may deliver a note to the chat representative reminding the representative to send pictures of available vehicles matching the user's interests. The notes may also be recorded with chat session statistics such as duration, start time, and end time of the chat session to assist the chat representative in recalling the chat session.

As should be apparent from the above explanation, embodiments disclosed herein describe the selection and delivery of video content within a chat application. Also, in the embodiments specifically disclosed herein, additional chat application features have been described. It should be noted that although the specification has described chat sessions between two parties, chat sessions may include three or more parties.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A method, comprising the steps of:
receiving a user-generated request associated with a server-side chat application;
collecting information associated with the user from a user-side chat application associated with the user;
selecting video content based on the collected information; and
sending the selected video content to the user-side chat application for display through an interface of the user-side chat application.

2. The method of claim 1, wherein the video content comprises a video advertisement.

3. The method of claim 1, wherein the server-side chat application is a chat application server that hosts the server-side chat application.

4. The method of claim 1, wherein the information associated with the user includes contact information or demographic information.

5. The method of claim 1, wherein the user-side chat application is comprised in a web browser.

6. The method of claim 1, wherein the information associated with the user includes information identifying a product or service in which the user is interested.

7. The method of claim 6, wherein the user generates the request by selecting a chat request interface from a web page.

8. The method of claim 1, wherein a product or service is associated with the user by inference from a web page from which the user generated the request.

9. The method of claim 1, wherein the video content is hosted by an ad server located remotely from a server-side chat application.

10. The method of claim 1, wherein the selected video content is displayed prior to an active chat session being initiated.

11. A method, comprising the steps of:
receiving a request to initiate a chat session, the request generated by a remote user;
initiating, from one or more servers, the chat session, within the chat application, between a chat representative and the user in response to the request;
monitoring, from one or more servers, for a video initiation event;
selecting, from one or more servers, video content based on an identified video initiation event; and
sending, from one or more servers, the selected video content to be displayed to the user within an interface of the chat application.

12. The method of claim 11, wherein the interface of the chat application provides a capability for the chat representative or the user to initiate a video chat session.

13. The method of claim 11, wherein the video initiation event occurs as a result of both the user and the chat representative consenting to initiate a video chat session.

14. The method of claim 11, wherein the interface of the chat application provides a capability for the chat representative or the user to initiate a telephone call.

15. The method of claim 11, wherein one or more interfaces associated with the chat application provide a capability for the chat representative or the user to initiate a voice chat session.

16. The method of claim 11, wherein one or more interfaces associated with the chat application provide a capability for the chat representative or the user to record notes.

17. The method of claim 11, wherein the user generates the request by responding affirmatively to an invitation to initiate a chat session.

18. The method of claim 11, wherein the video initiation event occurs as a result of a use of a keyword during the chat session.

19. A system, comprising:
a memory; and
a processor operatively coupled to the memory, the processor adapted to execute program code stored in the memory to:
receive a request to initiate a chat session from a remote device, the request generated by a user of the remote device;
initiate a chat application in response to the request;
collect information associated with the user through the chat application;
select video content based on the collected information; and
deliver the selected video content to the remote device such that the video content is displayed within an interface of the chat application on the remote device.

20. The system of claim 19, wherein the video content comprises a video advertisement.

21. The system of claim 19, wherein the information associated with the user comprises information identifying a product or service in which the user is interested.

22. The system of claim 21, wherein the information identifying the product or service in which the user is interested is inferred based on a web page from which the request was generated.
